(19) United States
(12) Patent Application Publication
(10) Pub. No.: US 2025/0335330 A1
(43) Pub. Date: Oct. 30, 2025

(54) ACTIVITY INSERTION IN PROCESS TREES FOR PROCESS MINING

(71) Applicant: UiPath, Inc., New York, NY (US)

(72) Inventors: Dennis BRONS, Eindhoven (NL); Roeland Johannus SCHEEPENS, Eindhoven (NL); Robin Johannes Pieter MENNENS, Eindhoven (NL)

(73) Assignee: UiPath, Inc., New York, NY (US)

(21) Appl. No.: 18/646,499

(22) Filed: Apr. 25, 2024

(51) Int. Cl. G06F 11/34

(52) U.S. Cl. CPC G06F 11/3495

(57) ABSTRACT

Systems and methods for inserting a new node in a process tree are provided. A process tree representing execution of a process is received. The process tree is traversed to identify a path of nodes. One or more candidate locations under each node of the path of nodes are determined for positioning a new node. A position score is determined for each of the one or more candidate locations for positioning the new node. The new node is inserted in the process tree at one or more of the one or more candidate locations based on the position scores. The process tree with the inserted new node is output.

### FIELD

The present invention generally relates to computer process mining, and more specifically, to activity insertion in process trees for process mining.

### BACKGROUND

Computer processes are sequences of activities executed by one or more computers to provide various services. In process mining, process tree discovery techniques are applied for generating process trees that represent execution of such computer processes. However, existing process tree discovery techniques are limited in the number of activities that the generated process trees support. Accordingly, an improved and/or alternative approach may be beneficial.

### SUMMARY

Certain embodiments of the present invention may provide alternatives or solutions to the problems and needs in the art that have not yet been fully identified, appreciated, or solved by current computer process mining technologies. For example, some embodiments of the present invention pertain to activity insertion in process trees for process mining.

In accordance with one or more embodiments, systems and methods for inserting a new node in a process tree are provided. A process tree representing execution of a process is received. The process tree is traversed to identify a path of nodes. One or more candidate locations under each node of the path of nodes are determined for positioning a new node. A position score for each of the one or more candidate locations is determined for positioning the new node. The new node is inserted in the process tree at one or more of the one or more candidate locations based on the position scores. The process tree with the inserted new node is output.

In one embodiment, the process tree is traversed by, for a particular node initially defined as being a root node of the process tree, selecting a child sub-tree of the particular node based on cut scores for cutting the process tree at the particular node. The selecting is repeated using a root node of the selected child sub-tree as the particular node until the root node of the selected child sub-tree is an activity node. The path of nodes is identified as being the particular nodes.

In one embodiment, where a specific node of the path of nodes is a relationship operator node for a sequence relationship, the one or more candidate locations are determined as being before all child nodes of the specific node, after all child nodes of the specific node, and between each pair of child nodes of the specific node.

In one embodiment, where a specific node of the path of nodes is a relationship operator node for an exclusive choice relationship or a parallel relationship, the one or more candidate locations are determined as being an arbitrary position under the specific node.

In one embodiment, the position score for positioning the new node at a respective candidate location of the one or more candidate locations comprises a cut score representing a measurement of a quality of relationships between activities in the process tree introduced by adding the new node at the respective candidate location.

In one embodiment, the process tree with the inserted new node is displayed on a display device.

In one embodiment, the process is an RPA (robotic process automation) process executed by one or more computing systems.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a computing system configured for implementing one or more embodiments of the present invention;

FIG. 2 shows a method for inserting an activity in a process tree, in accordance with one or more embodiments;

FIG. 3 shows an exemplary process tree, in accordance with one or more embodiments;

FIG. 4 shows a method for traversing a process tree to identify a path of nodes, in accordance with one or more embodiments;

FIGS. 5A-5C show traversal of a process tree for identifying a path of nodes for inserting a new node H, in accordance with one or more embodiments;

FIG. 6 shows a sub-tree showing candidate locations for positioning a new node under a node of a path of nodes where the node is a relationship operator node for the sequence relationship, in accordance with one or more embodiments;

FIG. 7 shows a sub-tree showing candidate locations for positioning a new node under a node of a path of nodes where the node is a relationship operator node for the exclusive choice relationship or the parallel relationship, in accordance with one or more embodiments;

FIG. 8 shows a sub-tree showing candidate locations for positioning a new node under a node of a path of nodes where the node is a relationship operator node for the loop relationship, in accordance with one or more embodiments; and

FIG. 9 shows new node H inserted in a process tree, in accordance with one or more embodiments.

Unless otherwise indicated, similar reference characters denote corresponding features consistently throughout the attached drawings.

### DETAILED DESCRIPTION OF THE EMBODIMENTS

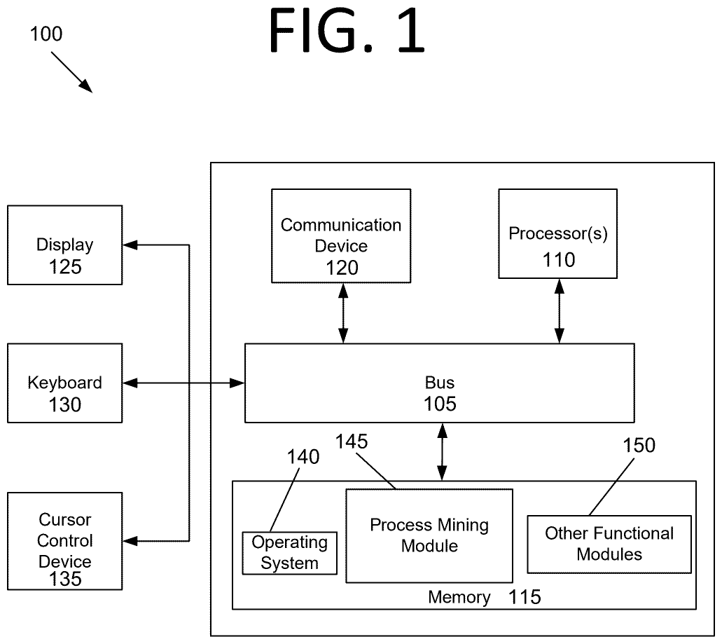

FIG. 1 is an architectural diagram illustrating a computing system 100 for assisted task mining, according to an embodiment of the present invention. In some embodiments, computing system 100 may be one or more of the computing systems depicted and/or described herein. Computing system 100 includes a bus 105 or other communication mechanism for communicating information, and processor(s) 110 coupled to bus 105 for processing information. Processor(s) 110 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 110 may also have multiple processing cores, and at least some of the cores may be configured to perform specific functions. Multi-parallel processing may be used in some embodiments. In certain embodiments, at least one of processor(s) 110 may be a neuromorphic circuit that includes processing elements that mimic biological neurons. In some embodiments, neuromorphic circuits may not require the typical components of a Von Neumann computing architecture.

Computing system 100 further includes a memory 115 for storing information and instructions to be executed by processor(s) 110. Memory 115 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 110 and may include volatile media, non-volatile media, or both. The media may also be removable, non-removable, or both. Computing system 100 includes a communication device 120, such as a transceiver, to provide access to a communications network via a wireless and/or wired connection. In some embodiments, communication device 120 may include one or more antennas that are singular, arrayed, phased, switched, beamforming, beamsteering, a combination thereof, and or any other antenna configuration without deviating from the scope of the invention.

Processor(s) 110 are further coupled via bus 105 to a display 125. Any suitable display device and haptic I/O may be used without deviating from the scope of the invention.

A keyboard 130 and a cursor control device 135, such as a computer mouse, a touchpad, etc., are further coupled to bus 105 to enable a user to interface with computing system 100. However, in certain embodiments, a physical keyboard and mouse may not be present, and the user may interact with the device solely through display 125 and/or a touchpad (not shown). Any type and combination of input devices may be used as a matter of design choice. In certain embodiments, no physical input device and/or display is present. For instance, the user may interact with computing system 100 remotely via another computing system in communication therewith, or computing system 100 may operate autonomously.

Memory 115 stores software modules that provide functionality when executed by processor(s) 110. The modules include an operating system 140 for computing system 100. The modules further include a process mining module 145 that is configured to perform all or part of the processes described herein or derivatives thereof. Computing system 100 may include one or more additional functional modules 150 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Computer processes may be executed by one or more computers to provide services for a number of different applications, such as, e.g., administrative applications (e.g., onboarding a new employee), procure-to-pay applications (e.g., purchasing, invoice management, and facilitating payment), and information technology applications (e.g., ticketing systems). In process mining, process trees representing execution of such computer processes are generated for further processing. Such process mining is typically performed on large amounts of process execution data. Existing approaches for generating process trees are limited in the number of activities that the generated process trees support.

Embodiments described herein provide for activity insertion in process trees for process mining. By inserting activities in process trees, the number of activities in process trees is expanded beyond what is possible by existing approaches for generating process trees. Advantageously, by performing process mining on such expanded process trees, the capabilities of process mining are thereby expanded.

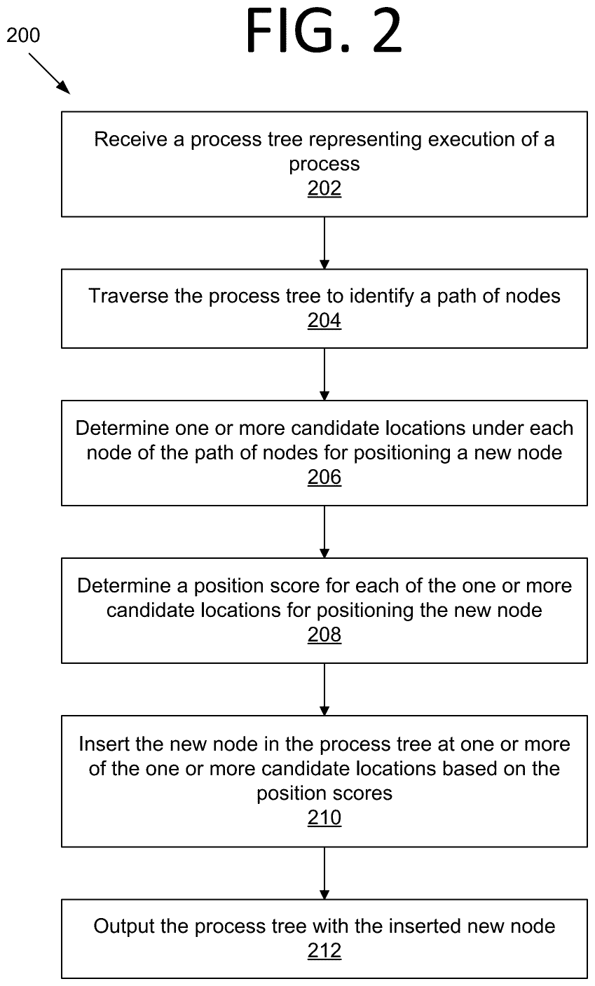

FIG. 2 shows a method 200 for inserting an activity in a process tree, in accordance with one or more embodiments. The steps and/or sub-steps of method 200 of FIG. 2 may be performed by one or more computing systems, such as, computing system 100 of FIG. 1.

At step 202 of FIG. 2, a process tree representing execution of a process is received. The process is a computer process executed using one or more computing systems, such as, e.g., computing system 100 of FIG. 1. In one example, the process is an RPA (robotic process automation) process for automatically performing an RPA task using one or more RPA robots executing on one or more computing systems.

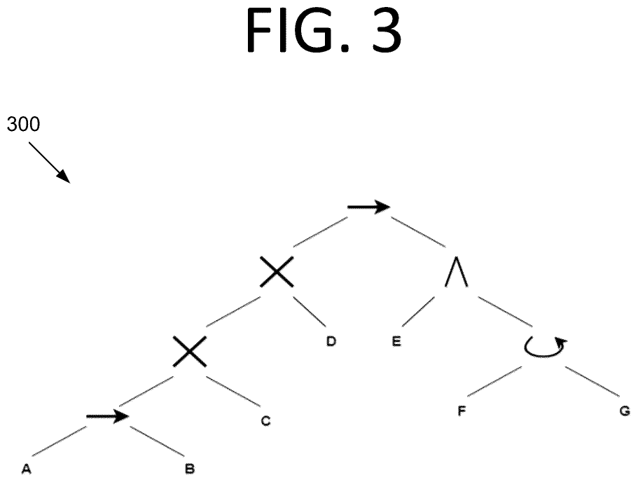

A process tree is a graphical representation of the sequential execution of the process. The process tree may be modeled as a directed graph, where each executed activity or operations of the process is represented as a node and the relationship or transition between activities or events is represented as edges connecting the nodes. FIG. 3 shows an exemplary process tree 300, in accordance with one or more embodiments. Process tree 300 comprises activity nodes for activities A, B, C, D, E, F, and G and relationship operator nodes for the sequence relationship (denoted→), the exclusive choice relationship (denoted X), the parallel relationship (denoted Λ), and the loop relationship (denoted [symbol] ).

The process tree may be generated using any suitable approach. In one embodiment, the process tree is generated using a probabilistic inductive miner system based on an event log recording execution of the process. In this embodiment, the event log is repeatedly and recursively split into sub-event logs. For each split, a relationship operator node is added to the process tree representing the behavior, such as, e.g., exclusive choice, sequence, parallel, or loop, between the sub-event logs. Activity nodes are recursively added for both sub-event logs as children to the relationship operator node. Before attempting to find a split in the event log, it is first determined whether a base case applies, in which case a leaf node is added representing either an activity of the process or a silent activity. This process is recursively performed for each sub-event log to provide for the recursive addition of nodes to a process tree to thereby generate the process tree representing execution of the process. Generating a process tree using a probabilistic inductive miner is further described in U.S. Pat. No. 11,500,756, the disclosure of which is incorporated herein by reference in its entirety. In another embodiment, the process tree is generated by translating the process model from a BPMN (business process modeling notation) model.

The process tree may be received, for example, by loading the process tree from a storage or memory of a computer system (e.g., memory 115 of computing system 100 of FIG. 1) or by receiving the process tree from a remote computer system (e.g., computing system 100 of FIG. 1).

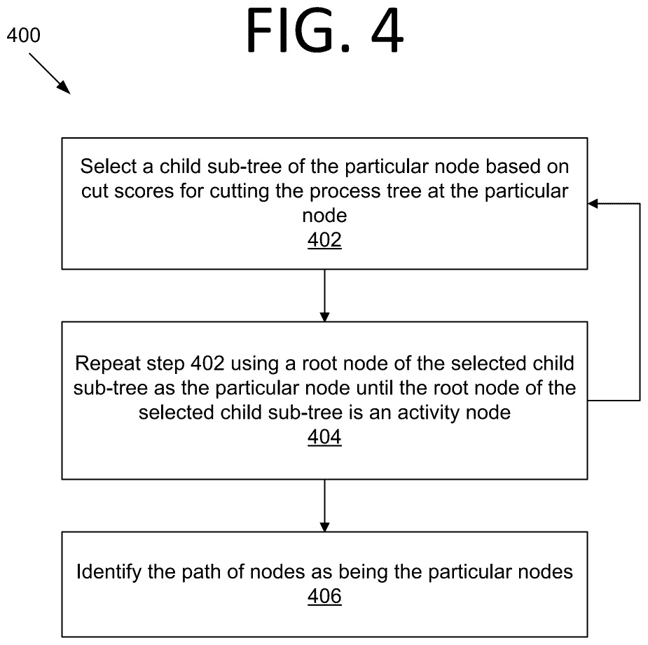

At step 204 of FIG. 2, the process tree is traversed to identify a path of nodes. The path of nodes comprises a plurality of nodes from a root node of the process tree to an activity node of the process tree. In one embodiment, the process tree is traversed according to method 400 of FIG. 4, described in further detail below.

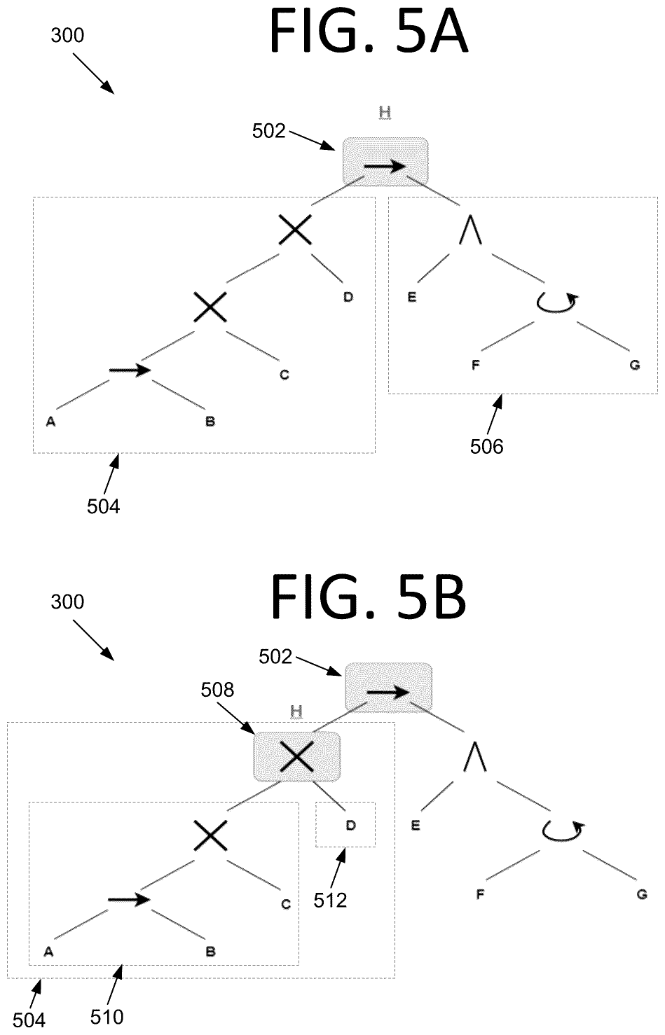

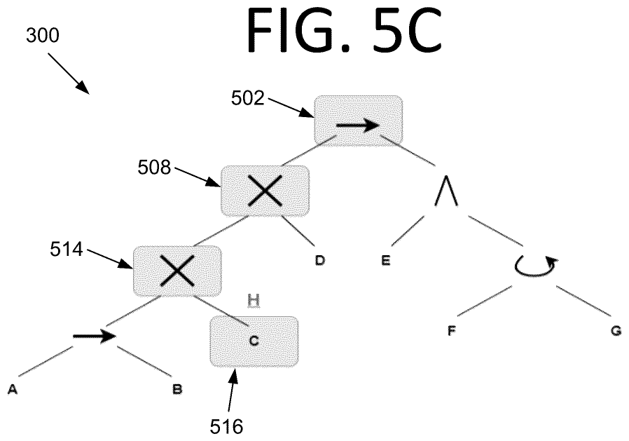

FIG. 4 shows a method 400 for traversing a process tree to identify a path of nodes, in accordance with one or more embodiments. The steps and/or sub-steps of method 400 of FIG. 4 may be performed by one or more computing systems, such as, computing system 100 of FIG. 1. Method 400 of FIG. 4 may be performed at step 204 of FIG. 2. Method 400 of FIG. 4 will be described with reference to FIGS. 5A-5C for traversing process tree 300 of FIG. 3 for identifying a path of nodes for inserting a new node H.

Step 402 of FIG. 4 is performed for a particular node that is initially defined during a first iteration as being a root node of the process tree. For example, as shown in FIGS. 5A-5C, the particular node is initially defined as root node 502 of process tree 300. At step 402 of FIG. 4, a child sub-tree of the particular node is selected based on cut scores for cutting the process tree at the particular node. A cut score is calculated for each child sub-tree of the particular node. During the calculation of the cut scores for each child sub-tree, the new node is placed in that child sub-tree and the cut scores are calculated to represent the likelihood that the new node is to be inserted into that child sub-tree.

In one embodiment, the cut scores are calculated for each respective child sub-tree by placing the new node in the respective child sub-tree. Activity relations scores are then calculated for the relational operator of the particular node for pairs of activities in each child sub-tree. The activity relations scores represent the probability that a relationship operator exists between the pairs of activities. Accumulated scores are next calculated for the relational operator of the particular node. The accumulated scores for the exclusive choice relationship operator, sequence relationship operator, and parallel relationship operator are determined by calculating the average activity relation score over each pair of activities in child sub-trees 21 and 22 for the cut location at the particular node. The accumulation scores for the loop relational operator are based on the combination of activity relation scores for the loop entry and loop exit relationship operator and the indirect loop relationship operator. The accumulation scores are then modified to determine the cut scores. Calculation of the cut scores is further described in U.S. Pat. No. 11,500,756, the disclosure of which is incorporated herein by reference in its entirety.

FIG. 5A shows traversal of process tree 300 for identifying a path of nodes for inserting a new node H during a first iteration, in accordance with one or more embodiments. During the first iteration, root node 502 of process tree 300 is initially defined as being the particular node. Cut scores are calculated for child sub-trees 504 and 506 of root node 502 if process tree 300 were cut at root node 502 (e.g., at step 402 of FIG. 4). The cut scores represent the likelihood that the new node is to be inserted into child sub-trees 504 and 506. In the example of FIG. 5A, child sub-tree 504 has a higher cut score than child sub-tree 506 and thus child sub-tree 504 is selected for traversal.

Referring back to FIG. 4, at step 404, step 402 is repeated using a root node of the selected child sub-tree as the particular node until the root node of the selected child sub-tree is an activity node. An activity node is node representing execution of an activity of the process.

FIG. 5B shows traversal of process tree 300 for identifying a path of nodes for inserting a new node H during a second iteration, in accordance with one or more embodiments. Child sub-tree 504 was selected for traversal during the first iteration (in FIG. 5A). During the second iteration, root node 508 of child sub-tree 504 is defined as being the particular node. Cut scores are calculated for child sub-trees 510 and 512 of root node 508 if process tree 300 were cut at root node 508 (e.g., at step 404 of FIG. 4). The cut scores represent the likelihood that the new node is to be inserted into child sub-trees 510 and 512. In the example of FIG. 5B, child sub-tree 510 has a higher cut score than child sub-tree 512 and thus child sub-tree 510 is selected for traversal.

Returning to FIG. 4, at step 406, the path of nodes is identified as being the particular nodes. The path of nodes starts from a root node of the process tree to an activity node of the process tree.

FIG. 5C shows complete traversal of process tree 300 for identifying a path of nodes for inserting a new node H through four iterations, in accordance with one or more embodiments. Process tree 300 was iteratively traversed over four iterations until reaching activity node 516 representing execution of activity C. During the traversal of process tree 300, nodes 502, 508, 514, and 516 were selected as being particular nodes of process tree 300 and thus the path of nodes is identified as being nodes 502, 508, 514, and 516. The path of nodes starts at root node 502 to activity node 516.

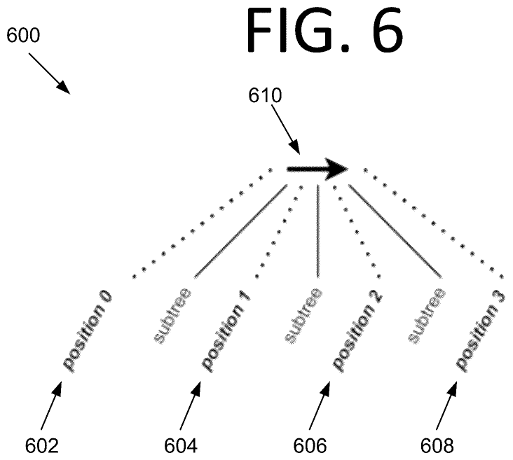

Returning to FIG. 2, at step 206, one or more candidate locations under each node of the path of nodes are determined for positioning the new node. There are various possible candidate locations for positioning the new node under a node of the path of nodes based on the operation type of the node, as illustrated in FIGS. 6-8, described in further detail below.

FIG. 6 shows a sub-tree 600 showing candidate locations for positioning a new node under node 610 of a path of nodes where node 610 is a relationship operator node for the sequence relationship (denoted->), in accordance with one or more embodiments. The candidate locations for positioning the new node under node 610 comprises position 602 before all other child nodes of node 610, position 608 after all other child nodes of node 610, and positions 604 or 608 between each pair of child nodes of node 610.

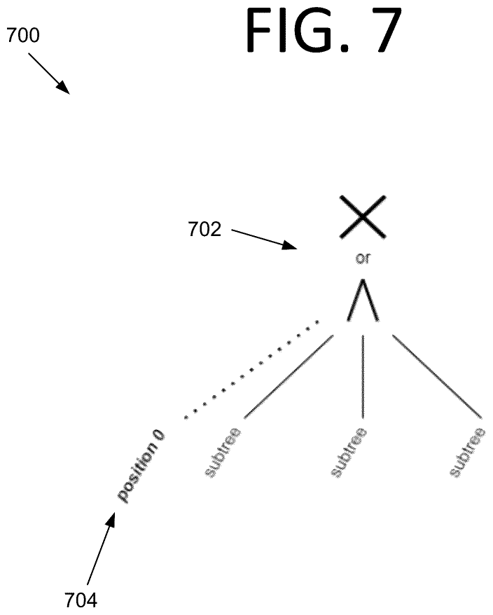

FIG. 7 shows a sub-tree 700 showing candidate locations for positioning a new node under node 702 of a path of nodes where node 702 is a relationship operator node for the exclusive choice relationship (denoted X) or the parallel relationship (denoted A), in accordance with one or more embodiments. In the exclusive choice relationship and the parallel relationship, the order of the child nodes of node 702 does not matter. Accordingly, the candidate location for positioning the new node under node 702 comprises an arbitrary position 704.

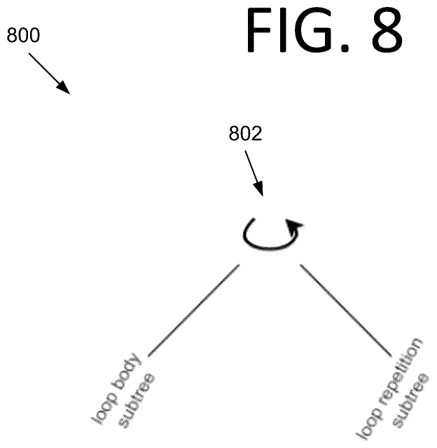

FIG. 8 shows a sub-tree 800 showing candidate locations for positioning a new node under node 802 of a path of nodes where node 802 is a relationship operator node for the loop relationship (denoted (5), in accordance with one or more embodiments. As shown in FIG. 8, sub-tree 800 comprises a single loop body and a single loop repetition sub-tree. There are no candidate locations directly under node 802. However, the new node may be placed deeper in the sub-tree 800. As a result, it is possible for the new node to be positioned directly under node 802 through simplification.

Returning to FIG. 2, at step 208, a position score is determined for each of the one or more candidate locations for positioning the new node. The position score for a candidate location is determined as the cut score for cutting the process tree at that candidate location. The cut score represents a measurement of the quality of relationships between the activities in the process tree introduced by adding the new node at that candidate location.

In one embodiment, referring back to FIG. 6, for the sequence relationship, the scores for positioning the new node at positions 602-608 may be determined as follows:
Position 602: sequence cut score of (new activity|activities of all sub-trees)
Positions 604 and 606: sequence cut score of (activities of sub-tree of the left|new activity|activities of sub-trees to the right)
Position 608: sequence cut score of (activities of all sub-trees|new activity)

In one embodiment, referring back to FIG. 7, for the exclusive or parallel relationship, the scores for positing the new node at position 704 may be determined as follows:
Position 704: exclusive or parallel cut of (new activity|activities of all sub-trees)

In one embodiment, referring back to FIG. 8, for the loop relationship, there are no candidate locations and thus no scores.

The cut scores operate on two sets of activities. For example, for each of positions 602, 604,606, and 608 in FIG. 6, two activity sets are formulated. For positions 602 and 608, they are on the outermost positions and, as such, the two activity sets are 1) the new node and 2) all activities in the sub-trees under the sequence node. For positions 604 and 606, they are between the subtrees under the sequence node. To emulate a partition with two cuts (leftSubtree|newActivity|rightSubtree), the average score of two cuts (leftSubtree|newActivity) and (newActivity|rightSubtree) is calculated. Similarly, for position 704 of FIG. 7, the two activity sets are 1) the new node and 2) all activities in the sub-trees under the exclusive or parallel node. The cut scores are calculated on the two sets of activities are described above, for example, in connection with step 402 of FIG. 4.

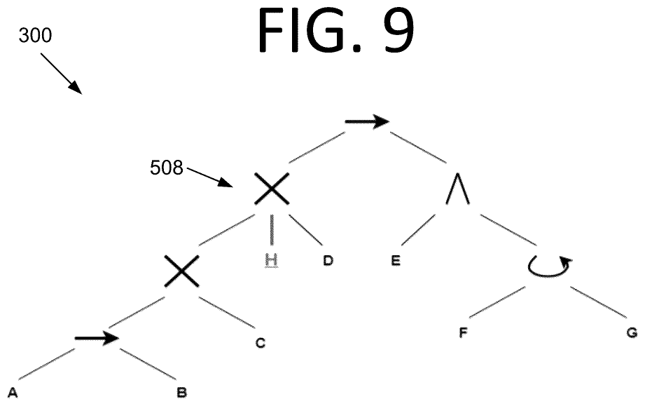

At step 210 of FIG. 2, the new node is inserted in the process tree at one or more of the one or more candidate locations based on the position scores. For example, the new node may be inserted at one or more of the one or more candidate locations with a highest score or scores. FIG. 9 shows new node H inserted in process tree 300, in accordance with one or more embodiments. New node H is inserted under the identified node 508 as a child node. As node 508 is a relational operator node for the exclusive choice relationship, new node H may be inserted at an arbitrary candidate location under node 508.

At step 212 of FIG. 2, the process tree with the inserted new node is output. For example, the process tree with the inserted new node can be output by displaying the process tree on a display device of a computer system (e.g., display 125 of computing system 100 of FIG. 1), storing the process tree on a memory or storage of a computer system (e.g., memory 115 of computing system 100 of FIG. 1), or by transmitting the process tree to a remote computer system (e.g., computing system 100 of FIG. 1).

The steps and sub-steps described herein, including the steps and sub-steps of FIGS. 2 and 4, may be performed by a computer program, encoding instructions for the processor(s) to perform at least part of the steps and sub-steps, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 110 of computing system 100 of FIG. 1) to implement all or part of the steps and sub-steps, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method comprising:
receiving a process tree representing execution of a process;
traversing the process tree to identify a path of nodes;
determining one or more candidate locations under each node of the path of nodes for positioning a new node;
determining a position score for each of the one or more candidate locations for positioning the new node;
inserting the new node in the process tree at one or more of the one or more candidate locations based on the position scores; and
outputting the process tree with the inserted new node.

2. The computer-implemented method of claim 1, wherein traversing the process tree to identify a path of nodes comprises:
for a particular node initially defined as being a root node of the process tree, selecting a child sub-tree of the particular node based on cut scores for cutting the process tree at the particular node;
repeating the selecting using a root node of the selected child sub-tree as the particular node until the root node of the selected child sub-tree is an activity node; and
identifying the path of nodes as being the particular nodes.

3. The computer-implemented method of claim 1, wherein determining one or more candidate locations under each node of the path of nodes for positioning a new node comprises:
where a specific node of the path of nodes is a relationship operator node for a sequence relationship, determining the one or more candidate locations as being before all child nodes of the specific node, after all child nodes of the specific node, and between each pair of child nodes of the specific node.

4. The computer-implemented method of claim 1, wherein determining one or more candidate locations under each node of the path of nodes for positioning a new node comprises:
where a specific node of the path of nodes is a relationship operator node for an exclusive choice relationship or a parallel relationship, determining the one or more candidate locations as being an arbitrary position under the specific node.

5. The computer-implemented method of claim 1, wherein the position score for positioning the new node at a respective candidate location of the one or more candidate locations comprises a cut score representing a measurement of a quality of relationships between activities in the process tree introduced by adding the new node at the respective candidate location.

6. The computer-implemented method of claim 1, wherein outputting the process tree with the inserted new node comprises:
displaying the process tree with the inserted new node on a display device.

7. The computer-implemented method of claim 1, wherein the process is an RPA (robotic process automation) process executed by one or more computing systems.

8. A system comprising:
a memory storing computer program instructions; and
at least one processor configured to execute the computer program instructions, the computer program instructions configured to cause the at least one processor to perform operations of:
receiving a process tree representing execution of a process;
traversing the process tree to identify a path of nodes;
determining one or more candidate locations under each node of the path of nodes for positioning a new node;
determining a position score for each of the one or more candidate locations for positioning the new node;
inserting the new node in the process tree at one or more of the one or more candidate locations based on the position scores; and
outputting the process tree with the inserted new node.

9. The system of claim 8, wherein traversing the process tree to identify a path of nodes comprises:
for a particular node initially defined as being a root node of the process tree, selecting a child sub-tree of the particular node based on cut scores for cutting the process tree at the particular node;
repeating the selecting using a root node of the selected child sub-tree as the particular node until the root node of the selected child sub-tree is an activity node; and
identifying the path of nodes as being the particular nodes.

10. The system of claim 8, wherein determining one or more candidate locations under each node of the path of nodes for positioning a new node comprises:
where a specific node of the path of nodes is a relationship operator node for a sequence relationship, determining the one or more candidate locations as being before all child nodes of the specific node, after all child nodes of the specific node, and between each pair of child nodes of the specific node.

11. The system of claim 8, wherein determining one or more candidate locations under each node of the path of nodes for positioning a new node comprises:
where a specific node of the path of nodes is a relationship operator node for an exclusive choice relationship or a parallel relationship, determining the one or more candidate locations as being an arbitrary position under the specific node.

12. The system of claim 8, wherein the position score for positioning the new node at a respective candidate location of the one or more candidate locations comprises a cut score representing a measurement of a quality of relationships between activities in the process tree introduced by adding the new node at the respective candidate location.

13. The system of claim 8, wherein outputting the process tree with the inserted new node comprises:
displaying the process tree with the inserted new node on a display device.

14. The system of claim 8, wherein the process is an RPA (robotic process automation) process executed by one or more computing systems.

15. A non-transitory computer-readable medium storing computer program instructions, the computer program instructions, when executed on at least one processor, cause the at least one processor to perform operations comprising:
receiving a process tree representing execution of a process;
traversing the process tree to identify a path of nodes;
determining one or more candidate locations under each node of the path of nodes for positioning a new node;
determining a position score for each of the one or more candidate locations for positioning the new node;
inserting the new node in the process tree at one or more of the one or more candidate locations based on the position scores; and
outputting the process tree with the inserted new node.

16. The non-transitory computer-readable medium of claim 15, wherein traversing the process tree to identify a path of nodes comprises:
for a particular node initially defined as being a root node of the process tree, selecting a child sub-tree of the particular node based on cut scores for cutting the process tree at the particular node;
repeating the selecting using a root node of the selected child sub-tree as the particular node until the root node of the selected child sub-tree is an activity node; and
identifying the path of nodes as being the particular nodes.

17. The non-transitory computer-readable medium of claim 15, wherein determining one or more candidate locations under each node of the path of nodes for positioning a new node comprises:
where a specific node of the path of nodes is a relationship operator node for a sequence relationship, determining the one or more candidate locations as being before all child nodes of the specific node, after all child nodes of the specific node, and between each pair of child nodes of the specific node.

18. The non-transitory computer-readable medium of claim 15, wherein determining one or more candidate locations under each node of the path of nodes for positioning a new node comprises:
where a specific node of the path of nodes is a relationship operator node for an exclusive choice relationship or a parallel relationship, determining the one or more candidate locations as being an arbitrary position under the specific node.

19. The non-transitory computer-readable medium of claim 15, wherein the position score for positioning the new node at a respective candidate location of the one or more candidate locations comprises a cut score representing a measurement of a quality of relationships between activities in the process tree introduced by adding the new node at the respective candidate location.

20. The non-transitory computer-readable medium of claim 15, wherein outputting the process tree with the inserted new node comprises:
displaying the process tree with the inserted new node on a display device.
